(19) United States
(12) Patent Application Publication
(10) Pub. No.: US 2011/0241390 A1
(43) Pub. Date: Oct. 6, 2011

(54) Angle Adjusting Cushion Structure for Bicycle

(76) Inventor: An-Ting Tsai, Fuhsing Hsiang (TW)

(21) Appl. No.: 12/753,468

(22) Filed: Apr. 2, 2010

(51) Int. Cl. B62J 1/00

(52) U.S. Cl. 297/215.15

(57) ABSTRACT

An angle adjusting cushion structure for a bicycle contains a body including a seat disposed on a central portion thereof, the seat including an arcuate abutting segment mounted on a bottom end thereof, and the abutting segment including plural first engaging teeth arranged thereon and a hole formed on a central portion thereof; a seat post including an arcuate connecting segment secured on a top end thereof, the connecting segment including plural second engaging teeth arranged on a top surface thereof and an elongated aperture disposed on a central portion thereof; a block member including a bore fixed on a central portion thereof; a locking element inserted to the bore and the aperture to be further locked in the hole of the seat so that the first engaging teeth of the abutting segment of the body engage with the second engaging teeth of the connecting segment of the seat post.

### BACKGROUND OF THE INVENTION

1. Field of the Invention

The present invention relates to a structure of a bicycle, and more particularly to an angle adjusting cushion structure for a bicycle that the locking element is inserted through the body and the seat post directly so as to be loosed to adjust the angle of the body quickly and easily.

2. Description of the Prior Art

Riding bicycles is a popular sport when people enjoy their leisure time, therefore a cushion of the bicycle has to be adjusted to a suitable angle based on different requirements.

Referring to FIG. 8, a conventional cushion structure for a bicycle comprises two rigid straps 10 disposed below a body (not shown), retained by a locking device 20, and linked with a seat post 30. However, such a conventional cushion structure includes many related components to increase a weight and to be assembled time consumingly, thus having high production cost. Furthermore, the rigid straps 10 and the seat post 30 are linked together by using the locking device 20, thereby having complicated adjusting operation.

The present invention has arisen to mitigate and/or obviate the afore-described disadvantages.

### SUMMARY OF THE INVENTION

The primary object of the present invention is to provide an angle adjusting cushion structure for a bicycle that can lower related components and production cost, and is light but strong to be assembled quickly and easily.

Another object of the present invention is to provide an angle adjusting cushion structure for a bicycle that the locking element is inserted through the body and the seat post directly so as to be loosed to adjust the angle of the body quickly and easily.

To obtain the above objectives, an angle adjusting cushion structure for a bicycle provided by a preferred embodiment of the present invention comprises

a body including a seat disposed on a central portion thereof, the seat including an arcuate abutting segment mounted on a bottom end thereof, and the abutting segment including a plurality of first engaging teeth arranged thereon continuously and including a hole formed on a central portion thereof;

a seat post including an arcuate connecting segment secured on a top end thereof, the connecting segment including a number of second engaging teeth arranged on a top surface thereof continuously, and including an elongated aperture disposed on a central portion thereof;

a block member including a bore fixed on a central portion thereof;

a locking element inserted to the bore of the block member and the aperture of the connecting segment of the seat post to be further locked in the hole of the seat of the body so that the first engaging teeth of the abutting segment of the body engage with the second engaging teeth of the connecting segment of the seat post.

### BRIEF DESCRIPTION OF THE DRAWINGS

FIG. 1 is a perspective view showing the exploded components of an angle adjusting cushion structure for a bicycle according to a preferred embodiment of the present invention;

FIG. 2 is another perspective view showing the exploded components of the angle adjusting cushion structure for the bicycle according to the preferred embodiment of the present invention;

FIG. 3 is a perspective view showing the assembly of the angle adjusting cushion structure for the bicycle according to the preferred embodiment of the present invention;

FIG. 4 is a cross sectional view showing the assembly of the angle adjusting cushion structure for the bicycle according to the preferred embodiment of the present invention;

FIG. 5 is another cross sectional view showing the assembly of the angle adjusting cushion structure for the bicycle according to the preferred embodiment of the present invention;

FIG. 6 is a cross sectional view showing the operation of the angle adjusting cushion structure for the bicycle according to the preferred embodiment of the present invention;

FIG. 7 is another cross sectional view showing the operation of the angle adjusting cushion structure for the bicycle according to the preferred embodiment of the present invention;

FIG. 8 is a cross sectional view showing the assembly of a conventional cushion structure for a bicycle.

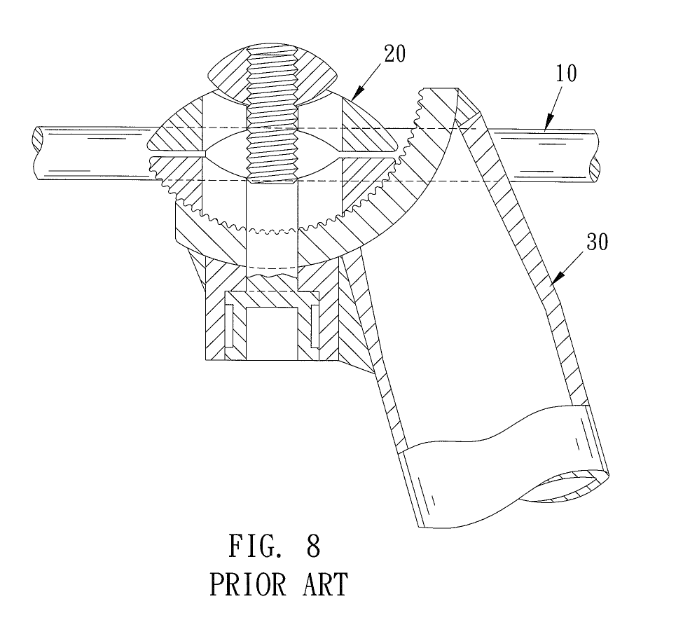

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

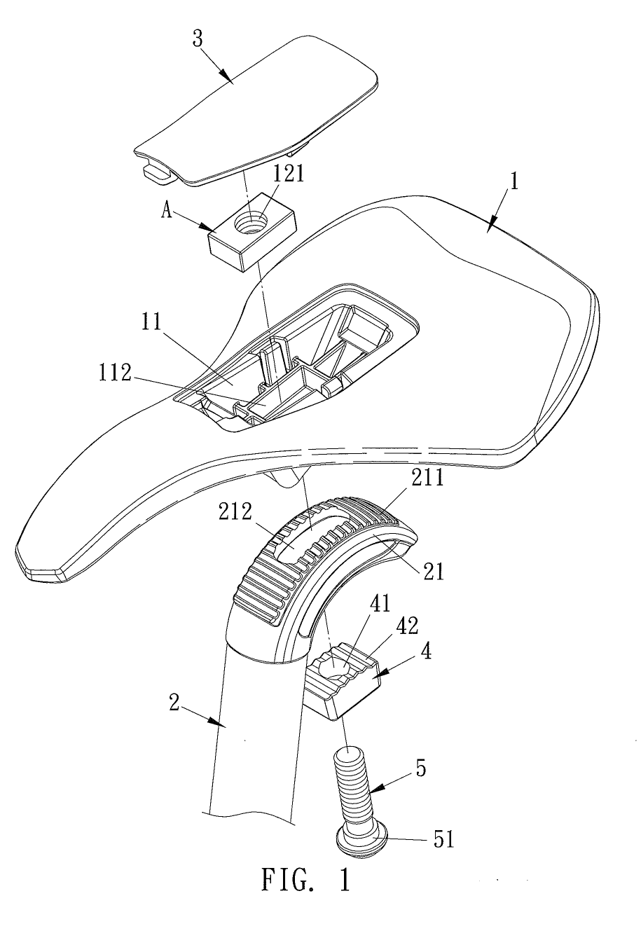

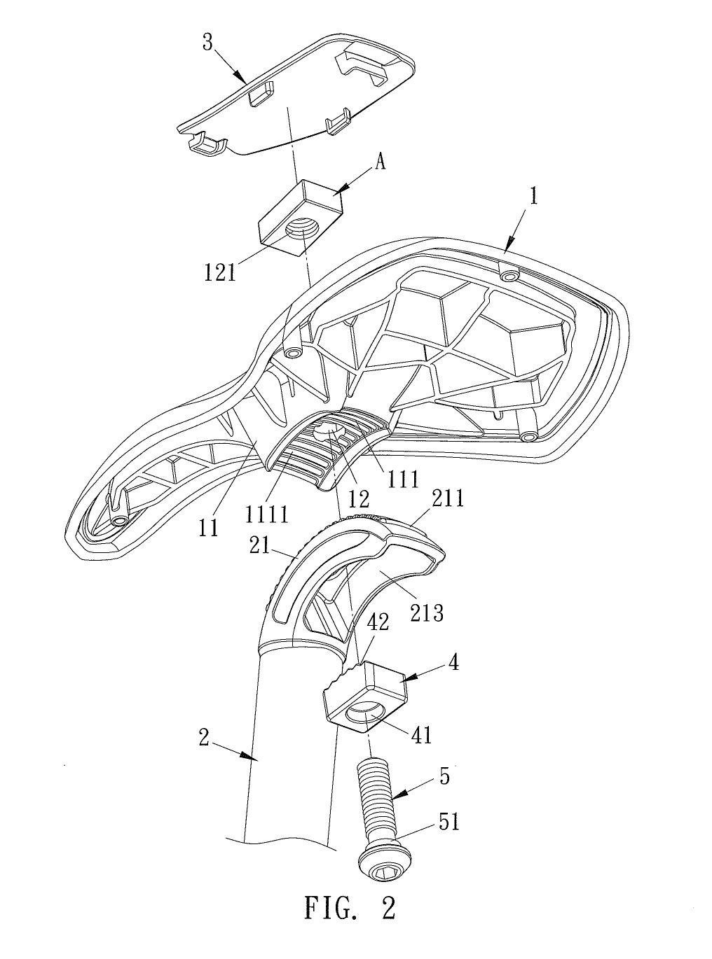

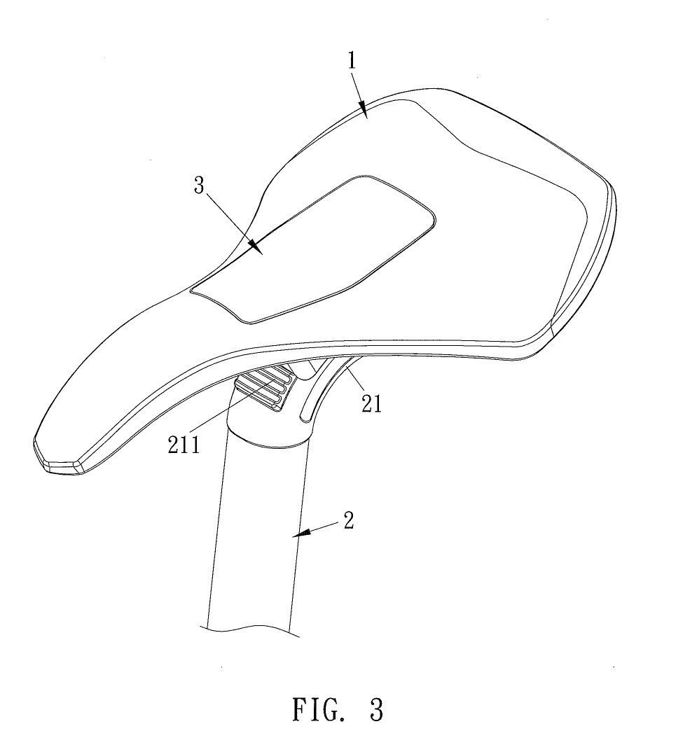

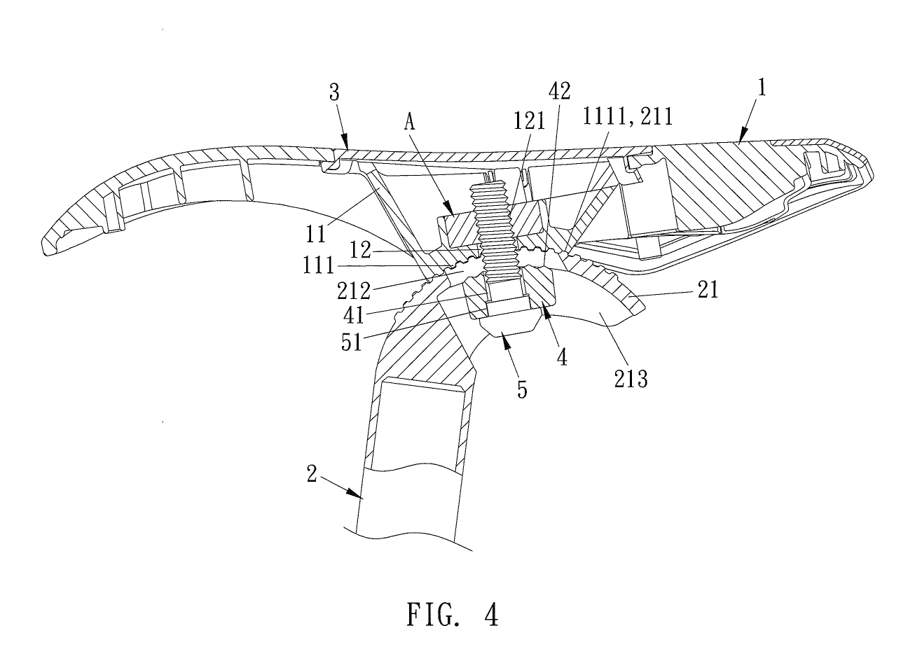

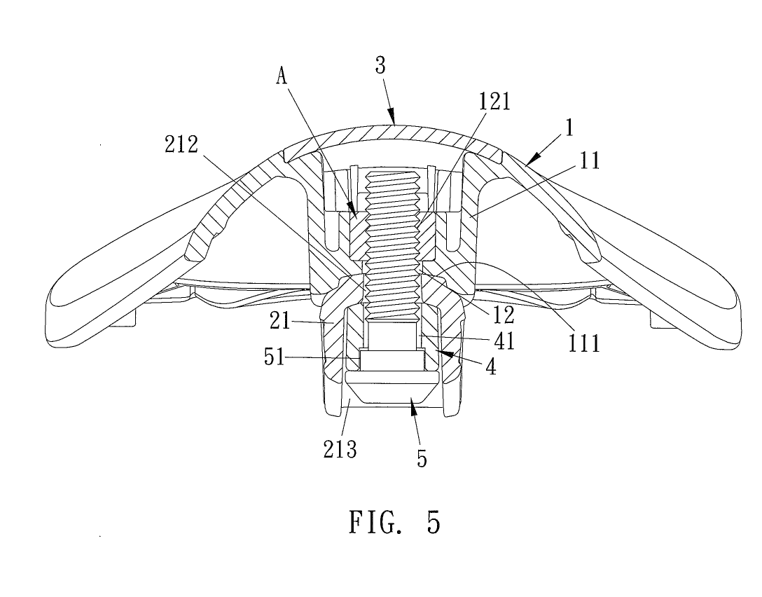

Referring to FIGS. 1-5, an angle adjusting cushion structure for a bicycle in accordance with a preferred embodiment of the present invention includes a body 1, a seat post 2, a cover 3, a block member 4, and a locking element 5, wherein the body 1 includes a seat 11 disposed on a central portion thereof, the seat 11 includes an arcuate abutting segment 111 mounted on a bottom end thereof, and the abutting segment 111 includes a plurality of first engaging teeth 1111 arranged thereon continuously and includes a hole 12 with inner threads 121 formed on a central portion thereof, the inner threads 121 are comprised of a retainer A fixed on a slot 112 of the seat 11, and the seat post 2 includes an arcuate connecting segment 21 secured on a top end thereof, the connecting segment 21 includes a number of second engaging teeth 211 arranged on a top surface thereof continuously, includes an elongated aperture 212 disposed on a central portion thereof, and includes a chamber 213 mounted on a bottom surface thereof to communicate with the aperture 212, the cover 3 is in response to an opening of the seat 11 of the body 1, a width of the block member 4 is larger than the aperture 212 of the connecting segment 21 of the seat post 2 to be received in the chamber 213 of the connecting segment 21 of the seat post 2, and the block member 4 includes a bore 41 with two stepped sections fixed on a central portion thereof and a toothed retaining surface 42 arranged on a top end thereof, the locking element 5 is a bolt and includes a projected loop 51 secured proximate to a head end thereof.

In assembly, the abutting segment 111 of the seat 11 of the body 1 is placed to the connecting segment 21 of the seat post 2, and the block member 4 is received in the chamber 213 of the connecting segment 21 of the seat post 2, then the locking element 5 is inserted to the bore 41 of the block member 4 and the aperture 212 of the connecting segment 21 of the seat post 2 to be further locked in the hole 12, therefore the locking element 5 is screwed with the inner threads 121 of the retainer A of the slot 112 of the seat 11, and the projected loop 51 of the locking element 5 is fitted in a large-diameter step section of the bore 41 to actuate the block member 4 to abut against a top surface of the chamber 213 of the connecting segment 21 of the seat post 2 by using its retaining surface 42, such that the first engaging teeth 1111 of the abutting segment 111 of the body 1 engage with the second engaging teeth 211 of the connecting segment 21 of the seat post 2 securely, and the cover 3 is retained or covered to the opening of the seat 11 of the body 1.

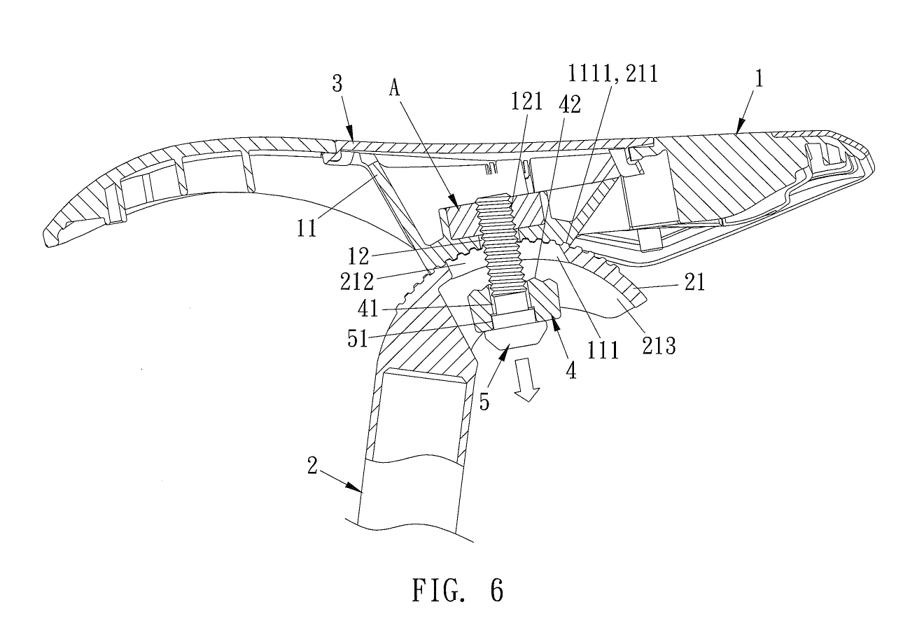

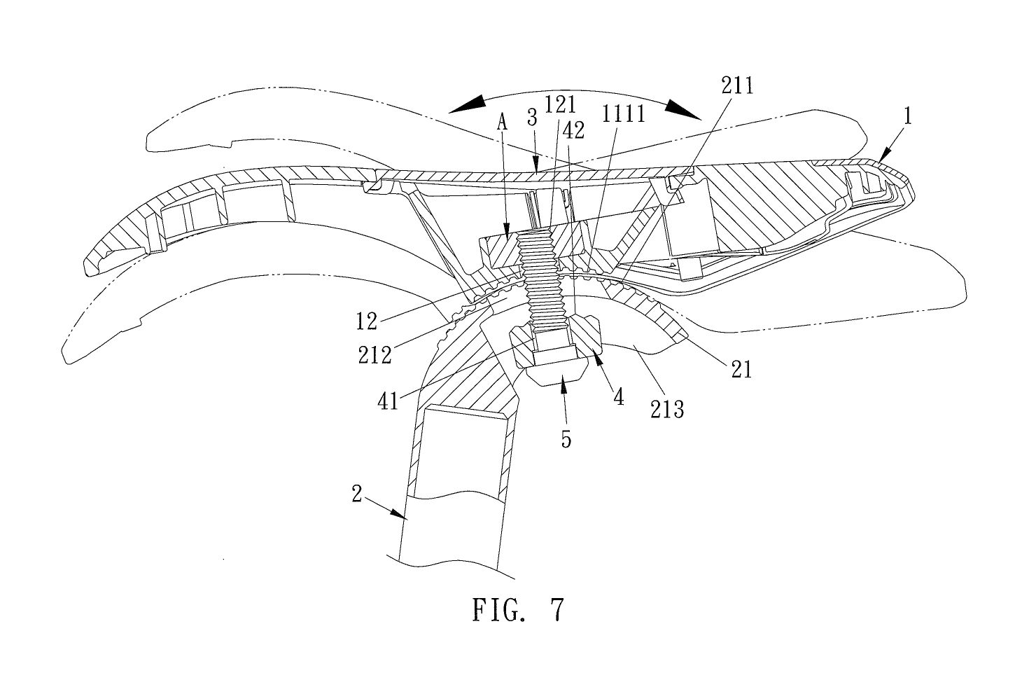

In operation, as shown in FIGS. 6 and 7, the locking element 5 is loosed so that the retaining surface 42 of the block member 4 disengages from the top surface of the chamber 213 of the connecting segment 21 of the seat post 2, and the first engaging teeth 1111 of the abutting segment 111 of the body 1 disengage from the second engaging teeth 211 of the connecting segment 21 of the seat post 2, hence the body 1 is moved forward or backward to adjust its angle. After the body 1 is adjusted to a predetermined angle, the locking element 5 is rotated tightly to actuate the block member 4 to abut against the top surface of the chamber 213 of the connecting segment 21 of the seat post 2 by ways of its retaining surface 42 such that the first engaging teeth 1111 of the abutting segment 111 of the body 1 is forced to engage with the second engaging teeth 211 of the connecting segment 21 of the seat post 2 securely.

Thereby, the angle adjusting cushion structure of the present invention has the following advantages:

1. The body 1 is locked with the seat post 2 directly to lower related components and production cost, and the cushion structure is light but strong to be assembled quickly and easily.

2. The locking element 5 is inserted through the body 1 and the seat post 2 directly so as to be loosed to adjust the angle of the body 1 quickly and easily.

While we have shown and described various embodiments in accordance with the present invention, it is clear to those skilled in the art that further embodiments may be made without departing from the scope of the present invention.

What is claimed:

1. An angle adjusting cushion structure for a bicycle comprising
a body including a seat disposed on a central portion thereof, the seat including an arcuate abutting segment mounted on a bottom end thereof, and the abutting segment including a plurality of first engaging teeth arranged thereon continuously and including a hole formed on a central portion thereof;
a seat post including an arcuate connecting segment secured on a top end thereof, the connecting segment including a number of second engaging teeth arranged on a top surface thereof continuously, and including an elongated aperture disposed on a central portion thereof;
a block member including a bore fixed on a central portion thereof;
a locking element inserted to the bore of the block member and the aperture of the connecting segment of the seat post to be further locked in the hole of the seat of the body so that the first engaging teeth of the abutting segment of the body engage with the second engaging teeth of the connecting segment of the seat post.

2. The angle adjusting cushion structure for the bicycle as claimed in claim 1, wherein the hole of the body includes inner threads arranged therein.

3. The angle adjusting cushion structure for the bicycle as claimed in claim 2, wherein the inner threads are comprised of a retainer fixed in the seat.

4. The angle adjusting cushion structure for the bicycle as claimed in claim 1, wherein the connecting segment includes a chamber mounted on a bottom surface thereof to communicate with the aperture and to receive the block member to slide therein.

5. The angle adjusting cushion structure for the bicycle as claimed in claim 1, wherein a cover is covered to an opening of the seat of the body.

6. The angle adjusting cushion structure for the bicycle as claimed in claim 1, wherein the bore of the block member includes two stepped sections, and the locking element includes a projected loop secured proximate to a head end thereof.

7. The angle adjusting cushion structure for the bicycle as claimed in claim 1, wherein the block member includes a toothed retaining surface arranged on a top end thereof.
